(19) United States
(12) Patent Application Publication
(10) Pub. No.: US 2025/0227599 A1
(43) Pub. Date: Jul. 10, 2025

(54) Apparatuses, Methods, and Computer Programs for Temporarily Unavailable Network Slices

(71) Applicant: Nokia Technologies Oy, Espoo (FI)

(72) Inventors: Alessio Casati, West Molesey Surrey (GB); Halit Murat Gursu, Munich (DE); Omer Bulakci, Munich (DE); Rajesh Babu Natarajan, Bangalore (IN); Sung Hwan Won, Flower Mound, TX (US)

(21) Appl. No.: 18/848,645

(22) PCT Filed: Apr. 4, 2023
(86) PCT No.: PCT/EP2023/058777

§ 371 Date: Sep. 19, 2024

(30) Foreign Application Priority Data
Apr. 7, 2022 (IN) 202241020973

(51) Int. Cl. H04W 48/08; H04W 8/22; H04W 76/30

(52) U.S. Cl. CPC H04W 48/08; H04W 8/22; H04W 76/30

(57) ABSTRACT

There is provided a method, computer program and apparatus for causing an apparatus for a network function to: obtain timing information for one or more network slices that a user equipment is allowed to use in a network: determine whether a network slice is currently unavailable to the user equipment based on the timing information; and invoke release of user plane resources in the network for a session associated with any network slice that is determined to be unavailable to the user equipment.

### FIELD

Various examples described herein generally relate to apparatus, methods, and computer programs, and more particularly (but not exclusively) to apparatus, methods and computer programs for network apparatuses.

### BACKGROUND

In general, a communication system can be seen as a facility that enables communication sessions between two or more entities such as user terminals, access nodes and/or other nodes by providing carriers between the various entities involved in the communications path. A communication system can be provided, for example, by means of a communication network and one or more compatible communication devices. The communication sessions may comprise, for example, communication of data for carrying communications such as voice, electronic mail (email), text message, multimedia and/or content data and so on. Content may be multicast or uni-cast to communication devices.

A user can access the communication system by means of an appropriate communication device or terminal. A communication device of a user is often referred to as user equipment (UE) or user device. The communication device may access a carrier provided by an access node and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture is the long-term evolution (LTE) or the Universal Mobile Telecommunications System (UMTS) radio-access technology. Another example communication system is so called 5G system that allows user equipment (UE) or user device to contact a 5G core via e.g. new radio (NR) access technology or via other access technology such as Untrusted access to 5GC or wireline access technology.

In 5G, a UE Registration Area (RA) comprises a list of one or more Tracking Areas (TA). A Tracking Area is a logical concept of an area where a UE can move around without updating the network. The network can allocate a list with one or more TAs to the UE.

### SUMMARY

According to a first aspect, there is provided an apparatus for a user equipment, the apparatus comprising means for: communicating with a network using a first session associated with a first slice and/or a first data network name; determining that the first slice and/or the first data network name is associated with timing information indicating that the first slice and/or the first data network name will stop being usable for the first session at a first time; determining whether the first slice and/or the first data network name will become usable at a second time, the second time falling after the first time; and when it is determined that the first slice and/or the first data network name will become usable for the first session at the second time, retaining context information associated with the first session; and when it is determined that the first slice and/or the first data network name will not become usable for the first session at the second time, autonomously releasing said context information.

The network may be considered to be an access point to a network, such as a Base Station, at least one network function in a core network, and/or a combination of both. In an example the network function in the core network may be considered to be an access and mobility function.

The apparatus may comprise means for signalling, to the network, an indication that the apparatus is capable of performing said determining whether the first slice and/or the first data network name will become usable at the second time.

In an example the network may include an access and mobility function.

The apparatus may comprise means for receiving, from the network, an indication that the network allows apparatus to perform said determining whether the first slice and/or the first data network name will become usable at the second time.

In an example, the network may be considered to be an access point to a network, such as a Base Station,

The apparatus may comprise means for when it is determined that the first slice and/or the first data network name will become usable for the first session at the second time, using the retained context information for communicating with a network using the first session at the second time.

The apparatus may comprise means for receiving the timing information from the network.

The apparatus may receive the timing information from a network function. For example, the apparatus may receive the timing information from at least one of: an access and mobility function, and/or an access point, and/or a user plane function, and/or a session management function.

The timing information may indicate that the first slice and/or the first data network name is available periodically.

The first slice and/or the first data network name may be associated with a second session, and the apparatus may comprise means for: communicating with the network using the second session; and when it is determined that the first slice and/or the first data network name will become usable for the second session at the second time, retaining context information associated with the second session; and when it is determined that the first slice and/or the first data network name will not become usable for the first session and second session at the second time, autonomously releasing said context information.

According to a second aspect, there is provided an apparatus for an access and mobility function, the apparatus comprising means for: signalling, to a session management function, a first request that a first session, associated with a first slice and/or a first data network name usable by a user equipment, be configured to allow an autonomous release of context information associated with the first session and/or to allow the retention of said context information when the first slice and/or the first data network name is temporarily unavailable, wherein the first slice and/or the first data network name is associated with timing information indicating that the first slice and/or the first data network name will stop being usable for the first session at a first time; receiving, from the session management function, an indication of whether the first request has been allowed by the session management function; and signalling said indication that the first request has been allowed to an access node when the first request has been allowed.

The apparatus may comprise means for receiving, from the user equipment, the first request.

The apparatus may comprise means for: determining a capability of the user equipment to perform the autonomous release of context information associated with the first session and/or to allow the retention of said context information when the first slice and/or the first data network name is temporarily unavailable; and generating the first request autonomously.

The apparatus may comprise means for locally storing an identifier of the first slice and/or the first data network name and the timing information with context information for the user equipment.

The apparatus may comprise means for providing an identifier of the first slice and/or the first data network name and the timing information to another access and mobility function as part of context information for the user equipment.

According to a third aspect, there is provided an apparatus for a Session Management Function and/or a User Plane Function, the apparatus comprising means for: determining that a first session, associated with a first slice and/or a first data network name usable by a user equipment, be configured to allow an autonomous release of context information associated with the first session and/or to allow the retention of said context information when the first slice is temporarily unavailable, wherein the first slice and/or the first data network name is associated with timing information indicating that the first slice and/or the first data network name will stop being usable for the first session at a first time; configuring and/or reconfiguring said first session in response to said determination; and signalling an indication of said configuration and/or reconfiguration to an access and mobility function.

The apparatus may comprise means for receiving, from the access and mobility function, a first request that the first session be configured to allow an autonomous release of context information associated with the first session and/or to allow the retention of said context information when the first slice and/or the first data network name is temporarily unavailable, wherein said determining is performed in response to receiving the first request.

The first request may comprise an indication that a user equipment associated with the first session is capable of performing an autonomous release of context information associated with the first session and/or of performing the retention of said context information when the first slice and/or the first data network name is temporarily unavailable, and whilst the context is retained, the apparatus may comprise means for causing dropping of downlink packets for the session without performing a paging operation.

The apparatus may comprise means for receiving the timing information from the access and mobility function.

The apparatus may comprise means for storing an identifier of the first slice and/or the first data network name and/or an Internet Protocol address allocated in context information for a user equipment associated with the first session.

According to a fourth aspect, there is provided an apparatus for an access node, the apparatus comprising means for: receiving from an access and mobility function, a first indication that a first session associated first context information is configured to allow first context information to be released autonomously by a user equipment when the first slice and/or the first data network name is determined to be unavailable and/or to be retained by the user equipment when the first slice and/or the first data network name is determined to be temporarily unavailable; and signalling the first indication to the user equipment.

The apparatus may comprise means for storing said first indication in context information for the user equipment.

The apparatus may comprise means for providing the first indication to another access node as part of context information for the user equipment.

According to a fifth aspect, there is provided an apparatus for a user equipment, the apparatus comprising means for: receiving timing information for one or more network slices that the user equipment is allowed to use in a network; determining whether a network slice is currently available to the user equipment based on the timing information; releasing user plane resources for a session associated with any network slice which is determined to be unavailable; and triggering a procedure to re-establish user plane resources for a session associated with the network slice that is determined to become available subsequent to said releasing.

According to a sixth aspect, there is provided an apparatus for a network function, the apparatus comprising means for: obtaining timing information for one or more network slices that a user equipment is allowed to use in a network; determining whether a network slice is currently unavailable to the user equipment based on the timing information; and invoking release of user plane resources in the network for a session associated with any network slice that is determined to be unavailable to the user equipment.

According to a seventh aspect, there is provided an apparatus for a user equipment, the apparatus comprising: at least one processor; and at least one memory comprising code that, when executed by the at least one processor, causes the apparatus to: communicate with a network using a first session associated with a first slice and/or a first data network name; determine that the first slice and/or the first data network name is associated with timing information indicating that the first slice and/or the first data network name will stop being usable for the first session at a first time; determine whether the first slice and/or the first data network name will become usable at a second time, the second time falling after the first time; and when it is determined that the first slice and/or the first data network name will become usable for the first session at the second time, retain context information associated with the first session; and when it is determined that the first slice and/or the first data network name will not become usable for the first session at the second time, autonomously release said context information.

The network may be considered to be an access point to a network, such as a Base Station, at least one network function in a core network, and/or a combination of both. In an example the network function in the core network may be considered to be an access and mobility function.

The apparatus may be caused to signal, to the network, an indication that the apparatus is capable of performing said determining whether the first slice and/or the first data network name will become usable at the second time.

The apparatus may be caused to receive, from the network, an indication that the network allows apparatus to perform said determining whether the first slice and/or the first data network name will become usable at the second time.

The apparatus may be caused to, for when it is determined that the first slice and/or the first data network name will become usable for the first session at the second time, use the retained context information for communicating with a network using the first session at the second time.

The apparatus may be caused to receive the timing information from the network.

The timing information may indicate that the first slice and/or the first data network name is available periodically.

The first slice and/or the first data network name may be associated with a second session, and the apparatus may be caused to: communicate with the network using the second session; and when it is determined that the first slice and/or the first data network name will become usable for the second session at the second time, retain context information associated with the second session; and when it is determined that the first slice and/or the first data network name will not become usable for the first session and second session at the second time, autonomously release said context information.

According to an eighth aspect, there is provided an apparatus for an access and mobility function, the apparatus comprising: at least one processor; and at least one memory comprising code that, when executed by the at least one processor, causes the apparatus to: signal, to a session management function, a first request that a first session, associated with a first slice and/or a first data network name usable by a user equipment, be configured to allow an autonomous release of context information associated with the first session and/or to allow the retention of said context information when the first slice and/or the first data network name is temporarily unavailable, wherein the first slice and/or the first data network name is associated with timing information indicating that the first slice and/or the first data network name will stop being usable for the first session at a first time; receive, from the session management function, an indication of whether the first request has been allowed by the session management function; and signal said indication that the first request has been allowed to an access node when the first request has been allowed.

The apparatus may be caused to receive, from the user equipment, the first request.

The apparatus may be caused to: determine a capability of the user equipment to perform the autonomous release of context information associated with the first session and/or to allow the retention of said context information when the first slice and/or the first data network name is temporarily unavailable; and generating the first request autonomously.

The apparatus may be caused to locally store an identifier of the first slice and/or the first data network name and the timing information with context information for the user equipment.

The apparatus may be caused to provide an identifier of the first slice and/or the first data network name and the timing information to another access and mobility function as part of context information for the user equipment.

According to a ninth aspect, there is provided an apparatus for a Session Management Function and/or a User Plane Function, the apparatus comprising: at least one processor; and at least one memory comprising code that, when executed by the at least one processor, causes the apparatus to: determine that a first session, associated with a first slice and/or a first data network name usable by a user equipment, be configured to allow an autonomous release of context information associated with the first session and/or to allow the retention of said context information when the first slice is temporarily unavailable, wherein the first slice and/or the first data network name is associated with timing information indicating that the first slice and/or the first data network name will stop being usable for the first session at a first time; configure and/or reconfiguring said first session in response to said determination; and signal an indication of said configuration and/or reconfiguration to an access and mobility function.

The apparatus may be caused to receive, from the access and mobility function, a first request that the first session be configured to allow an autonomous release of context information associated with the first session and/or to allow the retention of said context information when the first slice and/or the first data network name is temporarily unavailable, wherein said determining is performed in response to receiving the first request.

The first request may comprise an indication that a user equipment associated with the first session is capable of performing an autonomous release of context information associated with the first session and/or of performing the retention of said context information when the first slice and/or the first data network name is temporarily unavailable, and whilst the context is retained, the apparatus may be caused to cause dropping of downlink packets for the session without performing a paging operation.

The apparatus may comprise means for receiving the timing information from the access and mobility function.

The apparatus may be caused to store an identifier of the first slice and/or the first data network name and/or an Internet Protocol address allocated in context information for a user equipment associated with the first session.

According to a tenth aspect, there is provided an apparatus for an access node, the apparatus comprising: at least one processor; and at least one memory comprising code that, when executed by the at least one processor, causes the apparatus to: receive from an access and mobility function, a first indication that a first session associated first context information is configured to allow first context information to be released autonomously by a user equipment when the first slice and/or the first data network name is determined to be unavailable and/or to be retained by the user equipment when the first slice and/or the first data network name is determined to be temporarily unavailable; and signal the first indication to the user equipment.

The apparatus may be caused to store said first indication in context information for the user equipment.

The apparatus may be caused to provide the first indication to another access node as part of context information for the user equipment.

According to an eleventh aspect, there is provided an apparatus for a user equipment, the apparatus comprising: at least one processor; and at least one memory comprising code that, when executed by the at least one processor, causes the apparatus to: receive timing information for one or more network slices that the user equipment is allowed to use in a network; determine whether a network slice is currently available to the user equipment based on the timing information; release user plane resources for a session associated with any network slice which is determined to be unavailable; and trigger a procedure to re-establish user plane resources for a session associated with the network slice that is determined to become available subsequent to said releasing.

According to a twelfth aspect, there is provided an apparatus for a network function the apparatus comprising: at least one processor; and at least one memory comprising code that, when executed by the at least one processor, causes the apparatus to: obtain timing information for one or more network slices that a user equipment is allowed to use in a network; determine whether a network slice is currently unavailable to the user equipment based on the timing information; and invoke release of user plane resources in the network for a session associated with any network slice that is determined to be unavailable to the user equipment.

According to a thirteenth aspect, there is provided a method for an apparatus for a user equipment, the method comprising: communicating with a network using a first session associated with a first slice and/or a first data network name; determining that the first slice and/or the first data network name is associated with timing information indicating that the first slice and/or the first data network name will stop being usable for the first session at a first time; determining whether the first slice and/or the first data network name will become usable at a second time, the second time falling after the first time; and when it is determined that the first slice and/or the first data network name will become usable for the first session at the second time, retaining context information associated with the first session; and when it is determined that the first slice and/or the first data network name will not become usable for the first session at the second time, autonomously releasing said context information.

The network may be considered to be an access point to a network, such as a Base Station, at least one network function in a core network, and/or a combination of both. In an example the network function in the core network may be considered to be an access and mobility function.

The method may comprise signalling, to the network, an indication that the apparatus is capable of performing said determining whether the first slice and/or the first data network name will become usable at the second time.

The method may comprise receiving, from the network, an indication that the network allows apparatus to perform said determining whether the first slice and/or the first data network name will become usable at the second time.

The method may comprise, when it is determined that the first slice and/or the first data network name will become usable for the first session at the second time, using the retained context information for communicating with a network using the first session at the second time.

The method may comprise receiving the timing information from the network.

The timing information may indicate that the first slice and/or the first data network name is available periodically.

The first slice and/or the first data network name may be associated with a second session, and the method may comprise: communicating with the network using the second session; and when it is determined that the first slice and/or the first data network name will become usable for the second session at the second time, retaining context information associated with the second session; and when it is determined that the first slice and/or the first data network name will not become usable for the first session and second session at the second time, autonomously releasing said context information.

According to a fourteenth aspect, there is provided a method for an apparatus for an access and mobility function, the method comprising: signalling, to a session management function, a first request that a first session, associated with a first slice and/or a first data network name usable by a user equipment, be configured to allow an autonomous release of context information associated with the first session and/or to allow the retention of said context information when the first slice and/or the first data network name is temporarily unavailable, wherein the first slice and/or the first data network name is associated with timing information indicating that the first slice and/or the first data network name will stop being usable for the first session at a first time; receiving, from the session management function, an indication of whether the first request has been allowed by the session management function; and signalling said indication that the first request has been allowed to an access node when the first request has been allowed.

The method may comprise receiving, from the user equipment, the first request.

The method may comprise: determining a capability of the user equipment to perform the autonomous release of context information associated with the first session and/or to allow the retention of said context information when the first slice and/or the first data network name is temporarily unavailable; and generating the first request autonomously.

The method may comprise locally storing an identifier of the first slice and/or the first data network name and the timing information with context information for the user equipment.

The method may comprise providing an identifier of the first slice and/or the first data network name and the timing information to another access and mobility function as part of context information for the user equipment.

According to a fifteenth aspect, there is provided a method for an apparatus for a Session Management Function and/or a User Plane Function, the method comprising: determining that a first session, associated with a first slice and/or a first data network name usable by a user equipment, be configured to allow an autonomous release of context information associated with the first session and/or to allow the retention of said context information when the first slice is temporarily unavailable, wherein the first slice and/or the first data network name is associated with timing information indicating that the first slice and/or the first data network name will stop being usable for the first session at a first time; configuring and/or reconfiguring said first session in response to said determination; and signalling an indication of said configuration and/or reconfiguration to an access and mobility function.

The method may comprise receiving, from the access and mobility function, a first request that the first session be configured to allow an autonomous release of context information associated with the first session and/or to allow the retention of said context information when the first slice and/or the first data network name is temporarily unavailable, wherein said determining is performed in response to receiving the first request.

The first request may comprise an indication that a user equipment associated with the first session is capable of performing an autonomous release of context information associated with the first session and/or of performing the retention of said context information when the first slice and/or the first data network name is temporarily unavailable, and whilst the context is retained, the method may comprise causing dropping of downlink packets for the session without performing a paging operation.

The method may comprise receiving the timing information from the access and mobility function.

The method may comprise storing an identifier of the first slice and/or the first data network name and/or an Internet Protocol address allocated in context information for a user equipment associated with the first session.

According to a sixteenth aspect, there is provided a method for an apparatus for an access node, the method comprising: receiving from an access and mobility function, a first indication that a first session associated first context information is configured to allow first context information to be released autonomously by a user equipment when the first slice and/or the first data network name is determined to be unavailable and/or to be retained by the user equipment when the first slice and/or the first data network name is determined to be temporarily unavailable; and signalling the first indication to the user equipment.

The method may comprise storing said first indication in context information for the user equipment.

The method may comprise providing the first indication to another access node as part of context information for the user equipment.

According to a seventeenth aspect, there is provided a method for an apparatus for a user equipment, the method comprising: receiving timing information for one or more network slices that the user equipment is allowed to use in a network; determining whether a network slice is currently available to the user equipment based on the timing information; releasing user plane resources for a session associated with any network slice which is determined to be unavailable; and triggering a procedure to re-establish user plane resources for a session associated with the network slice that is determined to become available subsequent to said releasing.

According to an eighteenth aspect, there is provided a method for an apparatus for a network function, the method comprising: obtaining timing information for one or more network slices that a user equipment is allowed to use in a network; determining whether a network slice is currently unavailable to the user equipment based on the timing information; and invoking release of user plane resources in the network for a session associated with any network slice that is determined to be unavailable to the user equipment.

According to a nineteenth first aspect, there is provided an apparatus for a user equipment, the apparatus comprising: communicating circuitry for communicating with a network using a first session associated with a first slice and/or a first data network name; determining circuitry for determining that the first slice and/or the first data network name is associated with timing information indicating that the first slice and/or the first data network name will stop being usable for the first session at a first time; determining circuitry for determining whether the first slice and/or the first data network name will become usable at a second time, the second time falling after the first time; and retaining circuitry for, when it is determined that the first slice and/or the first data network name will become usable for the first session at the second time, retaining context information associated with the first session; and releasing circuitry for, when it is determined that the first slice and/or the first data network name will not become usable for the first session at the second time, autonomously releasing said context information.

The network may be considered to be an access point to a network, such as a Base Station, at least one network function in a core network, and/or a combination of both. In an example the network function in the core network may be considered to be an access and mobility function.

The apparatus may comprise signalling circuitry for signalling, to the network, an indication that the apparatus is capable of performing said determining whether the first slice and/or the first data network name will become usable at the second time.

The apparatus may comprise receiving circuitry for receiving, from the network, an indication that the network allows apparatus to perform said determining whether the first slice and/or the first data network name will become usable at the second time.

The apparatus may comprise using circuitry for, when it is determined that the first slice and/or the first data network name will become usable for the first session at the second time, using the retained context information for communicating with a network using the first session at the second time.

The apparatus may comprise receiving circuitry for receiving the timing information from the network.

The timing information may indicate that the first slice and/or the first data network name is available periodically.

The first slice and/or the first data network name may be associated with a second session, and the apparatus may comprise: communicating circuitry for communicating with the network using the second session; and retaining circuitry for, when it is determined that the first slice and/or the first data network name will become usable for the second session at the second time, retaining context information associated with the second session; and releasing circuitry for, when it is determined that the first slice and/or the first data network name will not become usable for the first session and second session at the second time, autonomously releasing said context information.

According to a twentieth aspect, there is provided an apparatus for an access and mobility function, the apparatus comprising: signalling circuitry for signalling, to a session management function, a first request that a first session, associated with a first slice and/or a first data network name usable by a user equipment, be configured to allow an autonomous release of context information associated with the first session and/or to allow the retention of said context information when the first slice and/or the first data network name is temporarily unavailable, wherein the first slice and/or the first data network name is associated with timing information indicating that the first slice and/or the first data network name will stop being usable for the first session at a first time; receiving circuitry for receiving, from the session management function, an indication of whether the first request has been allowed by the session management function; and signalling circuitry for signalling said indication that the first request has been allowed to an access node when the first request has been allowed.

The apparatus may comprise receiving circuitry for receiving, from the user equipment, the first request.

The apparatus may comprise: determining circuitry for determining a capability of the user equipment to perform the autonomous release of context information associated with the first session and/or to allow the retention of said context information when the first slice and/or the first data network name is temporarily unavailable; and generating the first request autonomously.

The apparatus may comprise storing circuitry for locally storing an identifier of the first slice and/or the first data network name and the timing information with context information for the user equipment.

The apparatus may comprise providing circuitry for providing an identifier of the first slice and/or the first data network name and the timing information to another access and mobility function as part of context information for the user equipment.

According to a twenty first aspect, there is provided an apparatus for a Session Management Function and/or a User Plane Function, the apparatus comprising: determining circuitry for determining that a first session, associated with a first slice and/or a first data network name usable by a user equipment, be configured to allow an autonomous release of context information associated with the first session and/or to allow the retention of said context information when the first slice is temporarily unavailable, wherein the first slice and/or the first data network name is associated with timing information indicating that the first slice and/or the first data network name will stop being usable for the first session at a first time; configuring circuitry for configuring and/or reconfiguring said first session in response to said determination; and signalling circuitry for signalling an indication of said configuration and/or reconfiguration to an access and mobility function.

The apparatus may comprise receiving circuitry for receiving, from the access and mobility function, a first request that the first session be configured to allow an autonomous release of context information associated with the first session and/or to allow the retention of said context information when the first slice and/or the first data network name is temporarily unavailable, wherein said determining is performed in response to receiving the first request.

The first request may comprise an indication that a user equipment associated with the first session is capable of performing an autonomous release of context information associated with the first session and/or of performing the retention of said context information when the first slice and/or the first data network name is temporarily unavailable, and whilst the context is retained, the apparatus may comprise causing circuitry for causing dropping of downlink packets for the session without performing a paging operation.

The apparatus may comprise receiving circuitry for receiving the timing information from the access and mobility function.

The apparatus may comprise storing circuitry for storing an identifier of the first slice and/or the first data network name and/or an Internet Protocol address allocated in context information for a user equipment associated with the first session.

According to a twenty second aspect, there is provided an apparatus for an access node, the apparatus comprising: receiving circuitry for receiving from an access and mobility function, a first indication that a first session associated first context information is configured to allow first context information to be released autonomously by a user equipment when the first slice and/or the first data network name is determined to be unavailable and/or to be retained by the user equipment when the first slice and/or the first data network name is determined to be temporarily unavailable; and signalling circuitry for signalling the first indication to the user equipment.

The apparatus may comprise storing circuitry for storing said first indication in context information for the user equipment.

The apparatus may comprise providing circuitry for providing the first indication to another access node as part of context information for the user equipment.

According to a twenty third aspect, there is provided an apparatus for a user equipment, the apparatus comprising: receiving circuitry for receiving timing information for one or more network slices that the user equipment is allowed to use in a network; determining circuitry for determining whether a network slice is currently available to the user equipment based on the timing information; releasing circuitry for releasing user plane resources for a session associated with any network slice which is determined to be unavailable; and triggering circuitry for triggering a procedure to re-establish user plane resources for a session associated with the network slice that is determined to become available subsequent to said releasing.

According to a twenty fourth aspect, there is provided an apparatus for a network function, the apparatus comprising: obtaining circuitry for obtaining timing information for one or more network slices that a user equipment is allowed to use in a network; determining whether a network slice is currently unavailable to the user equipment based on the timing information; and invoking circuitry for invoking release of user plane resources in the network for a session associated with any network slice that is determined to be unavailable to the user equipment.

According to a twenty fifth aspect, there is provided non-transitory computer readable medium comprising program instructions for causing an apparatus for a user equipment to perform at least the following: communicate with a network using a first session associated with a first slice and/or a first data network name; determine that the first slice and/or the first data network name is associated with timing information indicating that the first slice and/or the first data network name will stop being usable for the first session at a first time; determine whether the first slice and/or the first data network name will become usable at a second time, the second time falling after the first time; and when it is determined that the first slice and/or the first data network name will become usable for the first session at the second time, retain context information associated with the first session; and when it is determined that the first slice and/or the first data network name will not become usable for the first session at the second time, autonomously release said context information.

The network may be considered to be an access point to a network, such as a Base Station, at least one network function in a core network, and/or a combination of both. In an example the network function in the core network may be considered to be an access and mobility function.

The apparatus may be caused to signal, to the network, an indication that the apparatus is capable of performing said determining whether the first slice and/or the first data network name will become usable at the second time.

The apparatus may be caused to receive, from the network, an indication that the network allows apparatus to perform said determining whether the first slice and/or the first data network name will become usable at the second time.

The apparatus may be caused to, for when it is determined that the first slice and/or the first data network name will become usable for the first session at the second time, use the retained context information for communicating with a network using the first session at the second time.

The apparatus may be caused to receive the timing information from the network.

The timing information may indicate that the first slice and/or the first data network name is available periodically.

The first slice and/or the first data network name may be associated with a second session, and the apparatus may be caused to: communicate with the network using the second session; and when it is determined that the first slice and/or the first data network name will become usable for the second session at the second time, retain context information associated with the second session; and when it is determined that the first slice and/or the first data network name will not become usable for the first session and second session at the second time, autonomously release said context information.

According to a twenty sixth aspect, there is provided non-transitory computer readable medium comprising program instructions for causing an apparatus for an access and mobility function to perform at least the following: signal, to a session management function, a first request that a first session, associated with a first slice and/or a first data network name usable by a user equipment, be configured to allow an autonomous release of context information associated with the first session and/or to allow the retention of said context information when the first slice and/or the first data network name is temporarily unavailable, wherein the first slice and/or the first data network name is associated with timing information indicating that the first slice and/or the first data network name will stop being usable for the first session at a first time; receive, from the session management function, an indication of whether the first request has been allowed by the session management function; and signal said indication that the first request has been allowed to an access node when the first request has been allowed.

The apparatus may be caused to receive, from the user equipment, the first request.

The apparatus may be caused to: determine a capability of the user equipment to perform the autonomous release of context information associated with the first session and/or to allow the retention of said context information when the first slice and/or the first data network name is temporarily unavailable; and generating the first request autonomously.

The apparatus may be caused to locally store an identifier of the first slice and/or the first data network name and the timing information with context information for the user equipment.

The apparatus may be caused to provide an identifier of the first slice and/or the first data network name and the timing information to another access and mobility function as part of context information for the user equipment.

According to a twenty seventh aspect, there is provided non-transitory computer readable medium comprising program instructions for causing an apparatus for a session management function and/or a user plane function to perform at least the following: determine that a first session, associated with a first slice and/or a first data network name usable by a user equipment, be configured to allow an autonomous release of context information associated with the first session and/or to allow the retention of said context information when the first slice is temporarily unavailable, wherein the first slice and/or the first data network name is associated with timing information indicating that the first slice and/or the first data network name will stop being usable for the first session at a first time; configure and/or reconfiguring said first session in response to said determination; and signal an indication of said configuration and/or reconfiguration to an access and mobility function.

The apparatus may be caused to receive, from the access and mobility function, a first request that the first session be configured to allow an autonomous release of context information associated with the first session and/or to allow the retention of said context information when the first slice and/or the first data network name is temporarily unavailable, wherein said determining is performed in response to receiving the first request.

The first request may comprise an indication that a user equipment associated with the first session is capable of performing an autonomous release of context information associated with the first session and/or of performing the retention of said context information when the first slice and/or the first data network name is temporarily unavailable, and whilst the context is retained, the apparatus may be caused to cause dropping of downlink packets for the session without performing a paging operation.

The apparatus may comprise means for receiving the timing information from the access and mobility function.

The apparatus may be caused to store an identifier of the first slice and/or the first data network name and/or an Internet Protocol address allocated in context information for a user equipment associated with the first session.

According to a twenty eighth aspect, there is provided non-transitory computer readable medium comprising program instructions for causing an apparatus for an access node to perform at least the following: receive from an access and mobility function, a first indication that a first session associated first context information is configured to allow first context information to be released autonomously by a user equipment when the first slice and/or the first data network name is determined to be unavailable and/or to be retained by the user equipment when the first slice and/or the first data network name is determined to be temporarily unavailable; and signal the first indication to the user equipment.

The apparatus may be caused to store said first indication in context information for the user equipment.

The apparatus may be caused to provide the first indication to another access node as part of context information for the user equipment.

According to a twenty ninth aspect, there is provided non-transitory computer readable medium comprising program instructions for causing an apparatus for a user equipment to perform at least the following: receive timing information for one or more network slices that the user equipment is allowed to use in a network; determine whether a network slice is currently available to the user equipment based on the timing information; release user plane resources for a session associated with any network slice which is determined to be unavailable; and trigger a procedure to re-establish user plane resources for a session associated with the network slice that is determined to become available subsequent to said releasing.

According to a thirtieth aspect, there is provided non-transitory computer readable medium comprising program instructions for causing an apparatus for a network function to perform at least the following: obtain timing information for one or more network slices that a user equipment is allowed to use in a network; determine whether a network slice is currently unavailable to the user equipment based on the timing information; and invoke release of user plane resources in the network for a session associated with any network slice that is determined to be unavailable to the user equipment.

According to a thirty first aspect, there is provided a computer program product stored on a medium that may cause an apparatus to perform any method as described herein.

According to a thirty second aspect, there is provided an electronic device that may comprise apparatus as described herein.

According to a thirty third aspect, there is provided a chipset that may comprise an apparatus as described herein.

### BRIEF DESCRIPTION OF FIGURES

Some examples, will now be described, merely by way of illustration only, with reference to the accompanying drawings in which:

FIGS. 1A and 1B show a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 shows a schematic representation of a network;

FIG. 6 illustrates an example signal structure;

FIGS. 7A and 7B illustrate example signalling;

FIGS. 8 to 10 illustrate example signalling; and

FIGS. 11 to 16 are flow charts illustrating example operations that may be performed by example apparatus described herein.

### DETAILED DESCRIPTION

In the following description of examples, certain aspects are explained with reference to mobile communication devices capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems (for example, current 6G proposals).

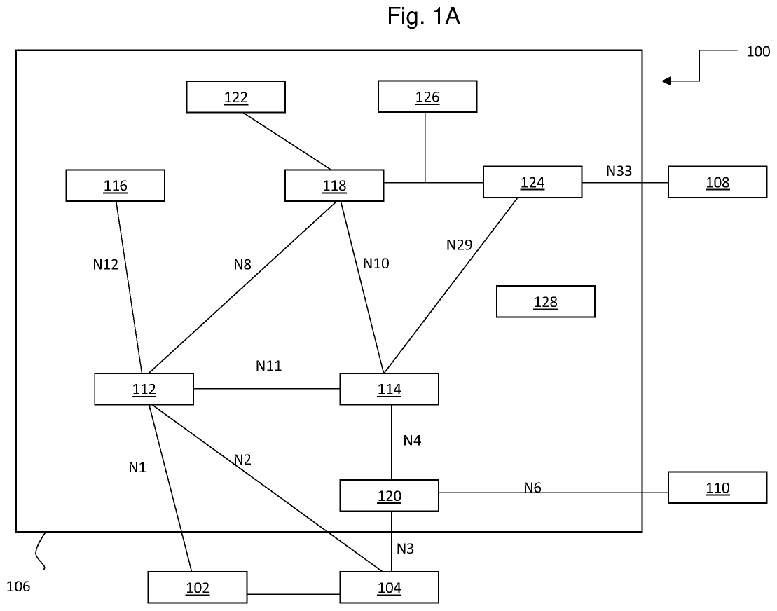

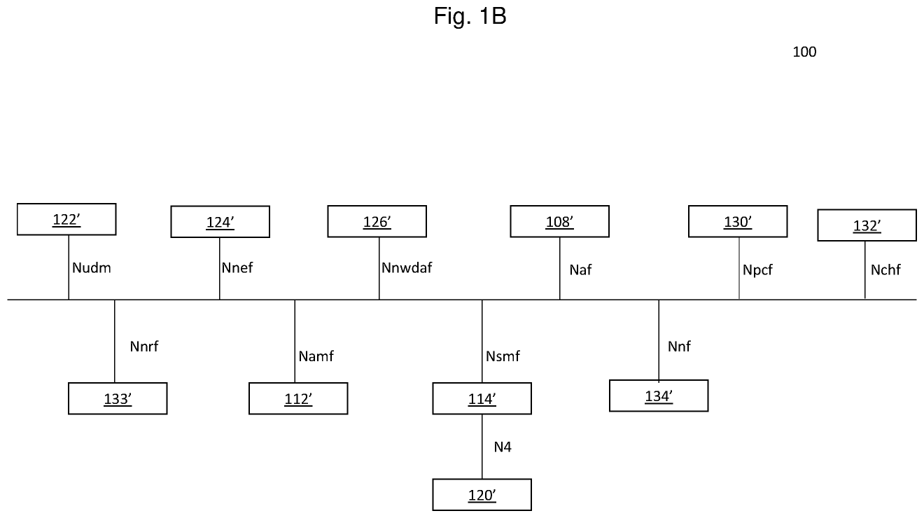

Before describing in detail the examples, certain general principles of a 5G wireless communication system are briefly explained with reference to FIGS. 1A and 1B.

FIG. 1A shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes.

The 5GC 106 may comprise one or more Access and Mobility Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. The role of an NEF is to provide secure exposure of network services (e.g. voice, data connectivity, charging, subscriber data, and so forth) towards a 3rd party. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

The network may further comprise a management data analytics service (MDAS) producer or MDAS Management Service (MnS) producer. The MDAS MnS producer may provide data analytics in the management plane considering parameters including, for example, load level and/or resource utilization. For example, the MDAS MnS producer for a network function (NF) may collect the NF's load-related performance data, e.g., resource usage status of the NF. The analysis of the collected data may provide forecast of resource usage information in a predefined future time window. This analysis may also recommend appropriate actions e.g., scaling of resources, admission control, load balancing of traffic, and so forth.

FIG. 1B shows a schematic representations of a 5GC represented in current 3GPP specifications. It is understood that this architecture is intended to illustrate potential components that may be comprised in a core network, and the presently described principles are not limited to core networks comprising only the described components.

FIG. 1B shows a 5GC 106′ comprising a UPF 120′ connected to an SMF 114′ over an N4 interface. The SMF 114′ is connected to each of a UDM 122′, an NEF 124′, an NWDAF 126′, an AF 108′, a Policy Control Function (PCF) 130′, an AMF 112′, and a Charging function 132′ over an interconnect medium that also connects these network functions to each other. The 5G core 106′ further comprises a network repository function (NRF) 133′ and a network function 134′ that connect to the interconnect medium.

3GPP refers to a group of organizations that develop and release different standardized communication protocols. 3GPP develops and publishes documents pertaining to a system of “Releases” (e.g., Release 15, Release 16, and beyond).

Network slicing is a key 5G (and later) feature for supporting different services using the same underlying mobile network infrastructure. 5G network slicing is a network architecture that enables the multiplexing of virtualized and independent logical networks on the same physical network infrastructure. Each network slice is an isolated end-to-end network tailored to fulfil diverse requirements requested by a particular application. Network slices can differ either in their service requirements (such as, for example, Ultra-Reliable Low Latency Communication (URLLC) and/or enhanced Mobile Broadband (eMBB) service requirements), and/or by the tenant that provides those services.

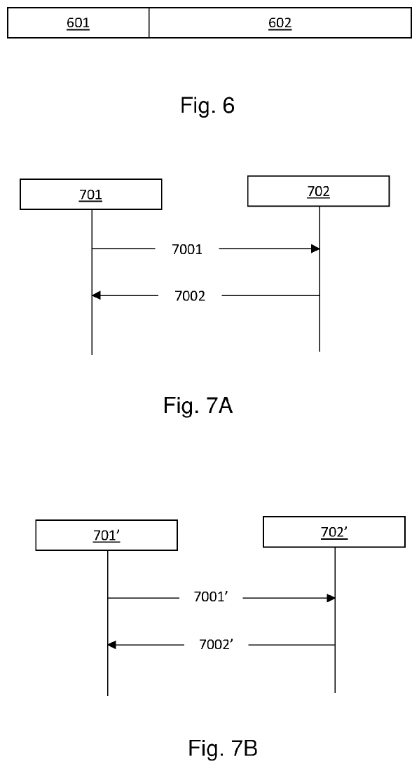

A network slice is uniquely identified via an identifier labelled as the S-NSSAI (Single-Network Slice Selection Assistance Information). The S-NSSAI may comprise a Slice Service Type (SST) field and a Slice Differentiator (SD) field (currently defined as having a total length of 32 bits). The S-NSSAI may comprise the SST field part while not comprising the SD part, in which case the length of S-NSSAI is 8 bits only. This is illustrated with respect to FIG. 6, which shows an SST field 601 of 8 bits and an optional SD field 602 of 24 bits.

Current 3GPP specifications allow a UE to be simultaneously connected and served by at most eight slices that correspond to eight S-NSSAIs. On other hand, each cell may support tens or even hundreds of slices, e.g., in the current specifications a tracking area can have a support up to 1024 network slices.

The SST field may have standardized and/or non-standardized values. Values 0 to 127 belong to the standardized SST range, and may be used to indicate that the accompanying slice is suitable for. For example, an SST represented by an SST value of 1 may indicate that the slice is suitable for handling of 5G eMBB. As another example, an SST represented by an SST value of 2 may indicate that that slice is suitable for handling of URLLC, etc. SD is operator-defined only in the current specifications.

Moreover, in the current specifications, neighbouring gNBs exchange slice support information per Tracking Area (TA) over an Xn interface during Xn Set-Up and NG-RAN Node Configuration Update procedures. This is illustrated with respect to FIGS. 7A and 7B.

FIG. 7A illustrates communications between a first Next Generation Radio Access Node (NG-RAN) node 701 and a second NG-RAN node 702 over an Xn interface therebetween.

At 7001, the first NG-RAN node 701 signals the second NG-RAN node 702. This signalling of 7001 may comprise a request to set up an Xn interface therebetween (e.g., the request may be an Xn Setup Request). The request may comprise information on slices supported by the first NG-RAN node 701.

At 7002, the second NG-RAN node 702 responds to the signalling of 7001. This response may be an Xn Setup response.

FIG. 7B illustrates communications between a first Next Generation Radio Access Node (NG-RAN) node 701′ and a second NG-RAN node 702′ over an Xn interface therebetween.

At 7001′, the first NG-RAN node 701′ signals the second NG-RAN node 702′. This signalling of 7001′ may comprise a request to update a configuration for the NG-RAN node (e.g., the request may be an NG-RAN node configuration update). The request may comprise information on slices supported by the first NG-RAN node 701′.

At 7002′, the second NG-RAN node 702′ responds to the signalling of 7001′. This response may be an NG-RAN node configuration update acknowledgement.

At any time, an AMF may provide a UE with a new Configured NSSAI for the Serving public land mobile network (PLMN)/domain, associated with mapping of the Configured NSSAI to Home PLMN (HPLMN) S-NSSAIs. The AMF provides an updated Configured NSSAI as specified in 3GPP TS 23.502.

Updates to the Allowed NSSAI and/or, if present, to the associated mapping of the Allowed NSSAI to HPLMN S-NSSAIs are also possible when the configuration update affects S-NSSAI(s) in the current Allowed NSSAI. An Allowed S-NSSAI/NSSAI may refer to an identifier of a slice that a user equipment is allowed to user for establishing sessions.

A UE having a configured NSSAI for its serving PLMN has been updated (e.g., as described in 3GPP TS 23.501) that has been requested to perform a Registration procedure, may initiate a Registration procedure to receive a new, valid Allowed NSSAI (see, for example, 3GPP TS 23.501).

The AMF, on receiving an indication from the Unified Data Management that subscription information for the UE has changed, signals an indication to the UE that the UE's subscription has changed. The AMF may further use updated subscription information received from the UDM to update the UE configuration (e.g. the Configured NSSAI in the UE can be updated with new or removed configured Slices the UE can potentially use in the network). When the UE is in a connection management IDLE state, the AMF may signal this updated subscription information indication and/or information using a trigger (such as, for example, a Network Triggered Service Request). Alternatively, When the UE is in a connection management IDLE state, the AMF may signal this updated subscription information indication and/or information by waiting until the UE is in a connection management CONNECTED state before initiating the signalling.

When a network slice is allowed to be used for a UE, the S-NSSAI of that slice may form part of the Allowed NSSAI that the UE stores and the network stores for the UE. Within a network slice in the Allowed NSSAI, the UE may establish a packet data unit (PDU) session. When a particular network slice is no longer available, the related S-NSSAI is no longer in the allowed NSSAI and the PDU session are also no longer available for the UE. In this case, the UE and the network do not retain any context for these sessions.

The following recognizes that it is possible that a network slice may be temporarily deployed. For example, a network slice may for example be periodically available (e.g. time of day based) in certain areas of the network.

The UE may receive information that certain network slices/S-NSSAIs are temporarily available. For example, the UE may receive an indication of the timing of a periodicity of which a network slice is available. For example, the UE may receive an indication of a periodic start and end of an availability of a particular network slice/S-NSSAI.

The UE may be configured to include the S-NSSAI of this network slice in the allowed NSSAI when the slice availability timing information indicates that S-NSSAI to be available.

Further, when the slice is available (i.e. the S-NSSAI of the slice is in the allowed NSSAI as it is within the availability time period) the UE can establish connectivity by requesting one or more PDU sessions to be established.

When the slice stops being available to the UE for any reason (including, although not limited to the indicated slice timing information), the S-NSSAI may be locally removed from the allowed NSSAI list, and any PDU session associated with that locally removed S-NSSAI may be considered not working any more. In other words, the UE and network may release any PDU session context and the PDU session is terminated/released.

This procedure results in the UE generating more signalling to request the connectivity again when the network slice is back in “available” state (i.e., in the allowed NSSAI) e.g. based on the timing information for the S-NSSAIs. For example, the UE may initiate a PDU session establishment procedure when the locally removed network slice is available again.

The following aims to address at least one of the above mentioned issues. In particular, the following aims to minimize signalling involved in resuming use of a temporarily network slice subsequent to the use of that network slice being discontinued.

When the UE registers, the UE may indicate to the network that the UE is capable of automatically/autonomously restoring and/or releasing sessions. The network may acknowledge this indication of the UE's capability and/or indicate that the network supports this ability of the UE. The indication of the UE's capability may be stored in the network as part of the UE's capability information. Autonomous actions performed by the apparatuses described in the present disclosure are actions which are performed by the apparatus solely based on already received information without requiring any further interaction with other apparatus, such as a Core Network node or a Base Station.

When a network slice that is available to the UE either periodically or only for a limited time is in the allowed NSSAI list for that UE, for the time that that slice is available, the UE may establish PDU session(s) for that network slice. Further, for each PDU session established based on such a slice, the UE may indicate that the UE intends to request automatic restoration of connectivity. This may be indicated when the PDU session is initially established. This may be indicted with timing information associated with the validity of the network slice for which the PDU session is being established.

The AMF may provide to a Session Management Function (SMF) for such a session, an authorization of the indication that the UE will be performing automatic/autonomous reconnection. This may be indicated by, for example, comprising the authorization in the Nsmf_PDUSession_CreateSMContext Request message signalled to the SMF for the PDU session in the network slice. This authorization may be accompanied by any periodicity/timing information associated with the validity of the slice on which the session is being established. The AMF may further indicate this authorization without receiving any explicit request from the UE when the AMF is aware that the UE can support the feature.

When the SMF receives this authorization, the SMF may establish the PDU session and can accept the automatic restoration/release (or not) in dependence on the SMF's policies and capabilities. For example, when the SMF is not capable of allowing this automatic reestablishment, the SMF may reject the authorization. As another example, when the SMF comprises a policy for that UE that causes the SMF to reject the authorization for automatic reestablishment of a PDU session, the SMF may reject the authorization. Conversely, when the SMF is capable of allowing this automatic reestablishment, the SMF may accept the authorization. As another example, when the SMF comprises a policy for that UE that causes the SMF to accept the authorization for automatic reestablishment of a PDU session, the SMF may accept the authorization.

In case of acceptance, the SMF may indicate this acceptance to the UE (e.g., via a non-access stratum message). The SMF may further provide information related to the reestablishment and/or release to the AMF so the AMF is also aware of the acceptance. This may be provided via, for example, a Namf_Communication_N1N2MessageTransfer message. The AMF may condition its behavior based on receipt of this acceptance, (i.e., the AMF may be configured to detect when a PDU session is expected to be released or to be periodically available). The AMF may further signal the acceptance to a gNB Radio Access Network (RAN) Entity and/or a Session Management function (SMF) and the SMF to a user plane function (UPF) associated with the UE. For the purpose of the present description, it is understood that operations described by the SMF may be performed by a UPF, and/or the SMF and UPF may be considered as operating in close cooperation. Analogous signalling may be performed in event of the SMF's refusal.

The AMF may provide an indication of the SMF's acceptance (or refusal) to the UE.

When the S-NSSAI subsequently becomes unavailable, the UE keeps any associated PDU sessions in a state where it cannot be used till the S-NSSAI is available again for those PDU sessions that are marked for automatic restoration (e.g., those sessions for which the SMF and/or AMF has indicated that they may be automatically/autonomously restored).

The AMF, RAN and SMF may also be configured to retain at least some context information for the dormant slice and associated connections. For example, the SMF may retain the UE context (including the allocated internet protocol (IP) address and user plane tunnel endpoints for the session). Further, the UPF may be requested to preserve the IP address associated session, but may but may discard (or buffer) any downlink data associated with that suspended session until the S-NSSAI resumes. Availability information of the S-NSSAI may be indicated to the UPF so the UPF automatically triggers this behaviour. This availability information may be indicated over, for example, an N4 interface between the SMF and the UPF.

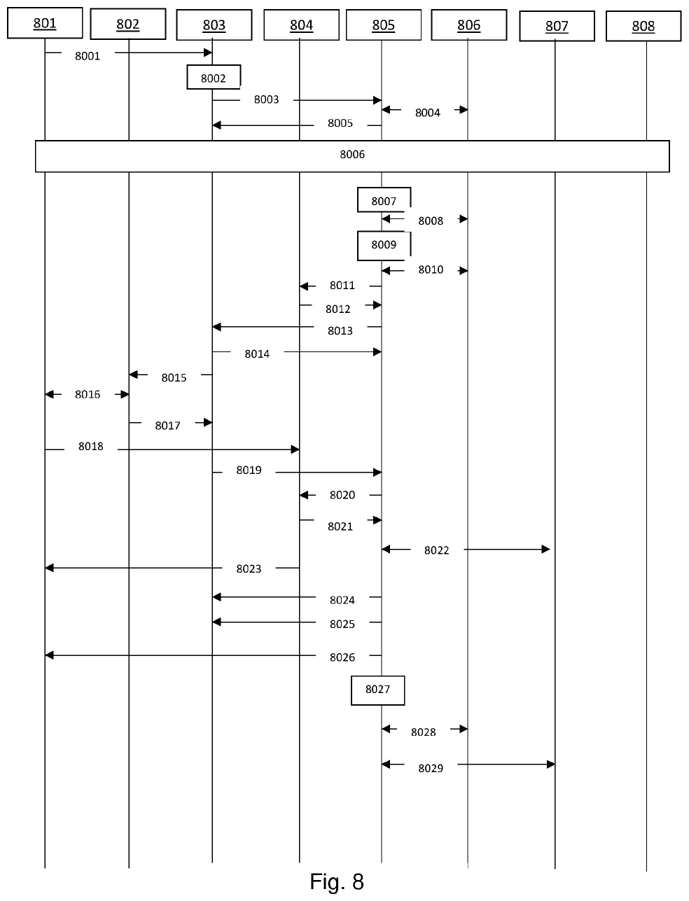

FIG. 8 illustrates potential signalling that may be performed between apparatus described herein.

FIG. 8 illustrates signalling that may be performed between a UE 801, an access node 802, and AMF 803, a UPF 804, an SMF 805, a PCF 806, a UDM 807, and a data network 808.

Although not shown in FIG. 8, the UE may have previously indicated to the network that the UE is capable of automatically/autonomously restoring previous connectivity in periodically available network slices or automatically release PDU sessions in one time network slice. When the network supports this, this support may be indicated to the UE 801 by the AMF 803.

At 8001, the UE signals a PDU session establishment request to the AMF 803. This PDU session establishment request may indicate a slice (e.g., via an S-NSSAI). This request of 8001 may comprise an indication that the slice is available for at least one limited time duration. For example, the signaling of 8001 may indicate that the S-NSSAI is available periodically or available for one limited time duration. The signalling of 8001 may further request automatic restoration and/or release of connectivity for the session being requested. It is understood that this automatic restoration and/or release request may be optional, as the automatic restoration/release may instead be network initiated (e.g., by the AMF 803).

At 8002, the AMF 803 selects SMF 805 for providing the session establishment request to.

At 8003, the AMF 803 signals the SMF 805. This signalling of 8003 may comprise a request to create a session for UE 801 based on the information received during 8001. This signalling may comprise, for example, an Nsmf_PDUSession_CreateSMContext Request. This signalling may comprise an indication that automatic restoration and/or release is requested for the session being established. This indication may be provided autonomously by the AMF based on the UE's capabilities, and/or based on receiving an explicit indication from the that the UE is requesting automatic restoration/release.

The signalling of 8003 may further comprise information pertinent to the automatic restoration and/or release of the session. For example, the signalling of 8003 may comprise an indication of at least time for which the associated slice for that session is active and available to the UE 801.

At 8004, the SMF retrieves subscription information for the UE from the PCF 806 and/or the UDM 807.

At 8005, the SMF 805 signals the AMF 803. This signalling of 8005 may comprise a response to the signalling of 8003. For example, this signalling of 8005 may comprise an Nsmf_PDUSession_CreateSMContext response message.

At 8006, the PDU session being established is authenticated and/or authorized.

At 8007, the SMF 805 selects PCF 806 for providing a session management policy for the session being established.

At 8008, a policy is associated with the session being established (e.g., via a session management policy association establishment procedure and/or via an SMF initiated Session Management Policy associated modification. 8008 may be effected via signalling between the SMF 805 and he PCF 806.

At 8009, the SMF selects UPF 804 for the session being established.

At 8010, the SMF 805 initiates a session management policy association modification with the PCF 806 in order to record the selected UPF in the policy.

At 8011, the SMF signals the selected UPF 804. This signalling of 8011 may comprise an N4 Session Establishment/Modification Request. This modification request may comprise information relating to the automatic release and/or reestablishment of the session being established. In other words, the SMF 805 may indicate the automatic restoration/release information to the UPF so that the UPF 804 preserves the context of UE for that session when the S-NSSAI for that session is no longer valid and for the UPF 804 to determine whether to retain (or drop) downlink data packets when that slice becomes unavailable.

At 8012, the SMF 805 responds to the signaling of 8011. This signalling may comprise an N4 Session Establishment/Modification response.

At 8013, the SMF 805 signals the AMF 804. This signalling of 8013 may comprise an N_amf_Communication_N1N2MessageTransfer message. This signalling of 8013 may comprise an indication that the SMF has accepted the establishment of the PDU session requested in 8003. This signalling of 8013 may comprise information related to the automatic restoration and/or release of the session. For example, this signalling may comprise timing information associated with the restoration and/or release of the session. This timing information may be the timing information already provided by the AMF to the SMF. The signalling of 8013 may comprise non-access stratum signalling.

At 8014, the AMF 803 may signal an acknowledgement of 8013 to the SMF 805.

At 8015, the AMF 803 may signal the access node 802. This signalling of 8015 may comprise a PDU session request (e.g., an N2 PDU session request). This signalling of 8015 may comprise information related to the automatic restoration and/or release of the session. For example, this signalling may comprise timing information associated with the restoration. This signalling of 8015 may comprise information related to slice restoration and/or release. The signalling of 8015 may comprise non-access stratum signalling. The signalling of 8015 may cause the access node 802 to retain the PDU session context in the UE context locally stored for UE 801 at the access node 802 when the S-NSSAI is not available, or to automatically erase the PDU session context from the UE context when the S-NSSAI is no longer available. Whether the PDU session is automatically retained or erased may depend on whether the session is associated with multiple active/validity times, or a single active/validity time.

At 8016, the access node signals the UE 801. The signalling of 8016 may comprise non access stratum signalling related to the automatic release and/or restoration of the session being established. This signalling of 8016 may comprise timing information related to when the slice associated with the session is valid. The timing information may indicate a plurality of discrete timing durations during which the slice associated with the session being established is valid. The timing information may indicate a single, discrete timing duration during which the slice associated with the session being established is valid.

At 8017, the access node may signal the AMF 803. This signaling of 8017 may comprise a response to the signalling of 8015. For example, this signalling of 8017 may comprise an N2 PDU session response. This signalling of 8017 may indicate that the RAN node and/or the UE accepts the automatic/autonomous reestablishment/release of the session.

At the end of 8017, assuming the automatic reestablishment/release request has been accepted by all nodes involved, the nodes may autonomously retain the UE/session context as long as the S-NSSAI is still allowed, or autonomously release the UE/session context when the S-NSSAI becomes permanently unavailable.

At 8018, the UE 801 signals first uplink data for the established session to the UPF 804.

At 8019, the AMF 803 signals an update request for the session to the SMF 805. This signalling of 8019 may comprise an Nsmf_PDUSession_UpdateSMContext Request.

At 8021, the SMF 805 signals the UPF 804. This signalling of 8021 may comprise a Session modification request. This signalling of 8021 may comprise an N4 Session modification request.

At 8022, the UPF 804 responds to the signalling of 8021. This response may comprise an N4 Session Modification Response.

At 8023, the SMF 805 and the UDM 806 may exchange registration information. The registration information may be, for example, a permanent subscriber identifier (e.g., a SUPI), an identifier for an SMF and/or an associated data network name to the SMF, a slice identifier (e.g., S-NSSAI), a PDU Session ID and an identifier for a Serving Network (e.g., see clause 5.18 of TS 23.501).

At 8024, the UPF 804 signals first downlink data for the session to the UE 801.

At 8025, the SMF 805 signals the AMF 803. This signalling may comprise a response to the signalling of 8019. This signalling of 8025 may comprise an Nsmf_PDUSession_UpdateSMContext Response.

At 8026, the SMF 805 signals the AMF 803. This signalling may comprise an Nsmf_PDUSession_SMContextStatusNotify message.

At 8027, the SMF 805 signals an address configuration for the UE (e.g., an IPv6 address configuration) to the UE 801 via the UPF 804.

At 8028, the SMF initiates an SMF policy association modification with the PCF 806.

At 8029, the SMF unsubscribes the session from the UDM 807.

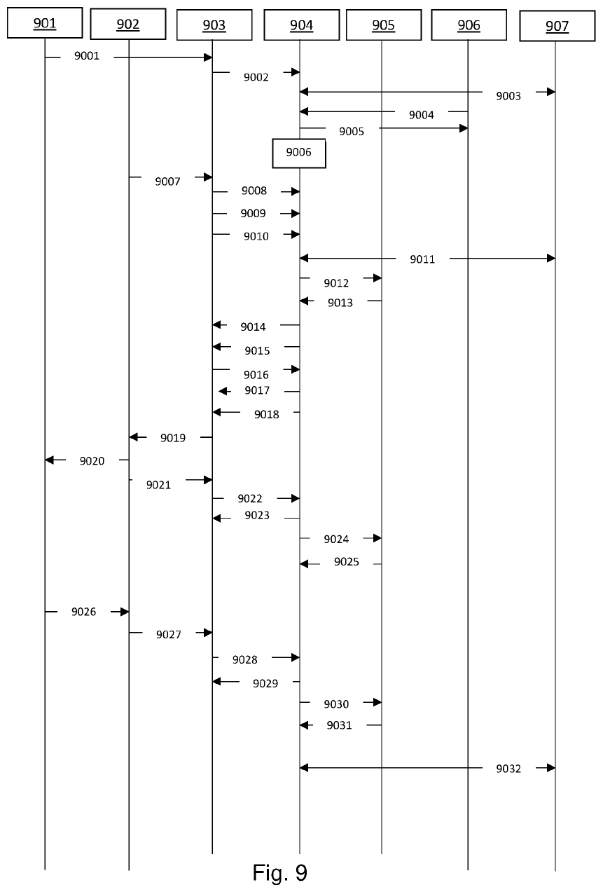

During the operation of FIG. 8, the AMF may determine to update the SMF with availability information received by the AMF from the access node. This may be useful when it is determined after session establishment that the session may be associated with a pre-known time-limited duration. In order to do this, the AMF may use a RAN-triggered PDU session modification procedure. This is illustrated below in relation to FIG. 9.

FIG. 9 illustrates signalling that may be performed between a UE 901, a network access node 902, an access and mobility function 903, an SMF 904, a UPF 905, a UDM 906, and a PCF 907.

During 9001, the UE signals a PDU session modification request to AMF 903.

During 9002, the AMF signals a PDU session update request to the SMF 904 in response to receipt of the signalling of 9001. This signalling may be, for example, an Nsmf_PDUSession_UpdateSMContext signalling.

During 9003, the SMF 904 and the PCF 907 exchange signalling for PCF-initiated SM policy associated modification.

During 9004, the SMF 904 receives signalling from UDM 906. This signalling of 9004 may comprise an Nudm_SDM_Notification.

During 9005, the SMF 904 responds to the signalling of 9004. This signalling of 9005 may acknowledge the notification of 9004.

During 9006, the SMF 904 may determine a quality of service update trigger.

During 9007, the access node 902 may signal the AMF 903. This signalling of 9007 may be an N2 message that indicates a PDU session (e.g., via a PDU session identifier) and session management information.

During 9008, the AMF 903 may signal a request to the SMF 904 to update the session management context in dependence on the signalling of 9007.

During 9009, the AMF 903 may signal a request to the SMF 904 to update the session management context in dependence on the signalling of 9007.

During 9010, the AMF 903 may signal a request to the SMF 904 to update the session management context in dependence on the signalling of 9007.

During 9011, the SMF 904 signals PCF 907. This signalling of 9011 may initiate (from the SMF) a policy association modification for the session. In other words, this signalling of 9011 may comprise an SMF-initiated session management policy association modification.

During 9012, the SMF may signal the UPF 905. This signalling of 9012 may comprise an N4 Session establishment and/or modification request.

During 9013, the SMF 904 may receive, from the UPF 905, a response to the signalling of 9012. This response may comprise, for example, an N4 Session establishment and/or modification response.

During 9014, the SMF 904 signals the AMF 903. This signaling of 9014 may comprise a response to the signalling of 9008. This signalling may comprise, for example, an Nsmf_PDUSession_UpdateSMContext response message.

During 9015, the SMF 904 signals the AMF 903. This signalling of 9015 may comprise an Namf_Communication_N1N2MessageTransfer signalling.

During 9016, the AMF 903 may respond to the signalling of 9015.

During 9017, the SMF 904 signals the AMF 903. This signalling of 9017 may comprise an Nsmf_PDUSession_SMContextStatusNotify signalling.

During 9018, the SMF 904 signals the AMF 903. This signalling of 9018 may comprise an Nsmf_PDUSession_SMContextStatusNotify signalling

During 9019, the AMF 903 signals an N2 message to the access node 902.

During 9020, the access node 902 exchanges signalling with the user equipment 901. This signalling of 9020 may indicate an access node-specific resource modification of transport for the session (for example, a PDU session modification command).

During 9021, the access node 902 signals an N2 message to the AMF 903.

During 9022, the AMF 903 signals an update session management context request to the SMF 904. The signalling of 9022 may comprise an Nsmf_PDUSession_UpdateSMContext Request.

During 9023, the SMF 904 responds to the signalling of 9022. The signalling of 9023 may comprise an Nsmf_PDUSession_UpdateSMContext Response.

During 9024, the SMF 904 signals an N4 session modification request to the UPF 905.

During 9025, the UPF 905 responds to the signalling of 9024 with an N4 Session Modification Response.

During 9026, the UE 901 signals a PDU session Modification Command acknowledgement to the access node 902.

During 9027, the access node signals an N2 non-access stratum uplink transfer request to the AMF 903.

During 9028, the AMF 903 signals a update session management context request to the SMF 904. The signalling of 9028 may comprise an Nsmf_PDUSession_UpdateSMContext Request.

During 9029, the SMF 904 responds to the signalling of 9022. The signalling of 9029 may comprise an Nsmf_PDUSession_UpdateSMContext Response.

During 9030, the SMF 904 signals an N4 session modification request to the UPF 905.

During 9031, the UPF 905 responds to the signalling of 9024 with an N4 Session Modification Response.

During 9032, the SMF 904 signals PCF 907. This signalling of 9032 may initiate (from the SMF) a policy association modification for the session. In other words, this signalling of 9011 may comprise an SMF-initiated session management policy association modification.

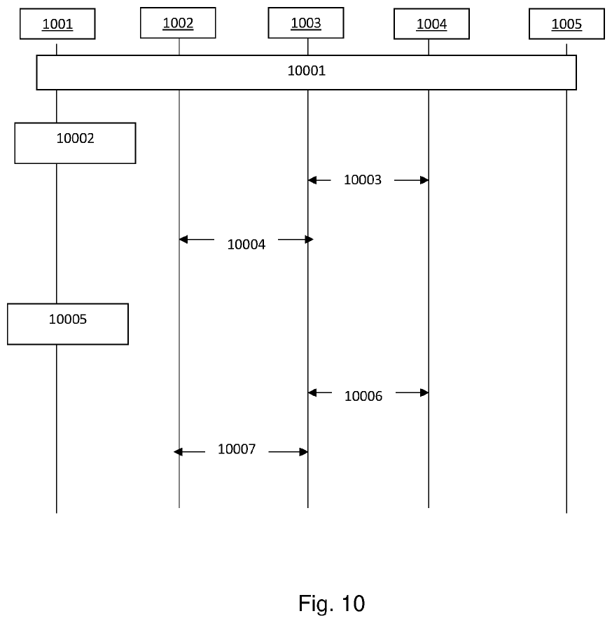

Certain elements of the present disclosure are illustrated with respect to the signalling diagram of FIG. 10.

FIG. 10 illustrates signalling that may be performed between a UE 1001, an access point 1002, an AMF 1003, an SMF (and/or UPF) 1004, and an unspecified NF 1005.

During 10001, the UE 1001 registers with the network. This registration may be triggered by the UE 1001. During the registration procedure, the AMF 1003 may provide the UE 1001 with a list of slices (e.g., a list of S-NSSAIs). Each of the slices in the list may be associated with: timing information for that slice; and an indication on the handling of a PDU session associated with that slice when the slice becomes unavailable (e.g. release or keep the PDU session when the slice associated with the PDU session becomes unavailable). After the registration procedure is completed, the UE may initiate the PDU session establishment procedure. This may be as described in relation to FIG. 8.

10002 to 10004 relate to a scenario in which a PDU session associated with a particular slice/S-NSSAI is not released when the slice is unavailable.

In this case, at 10002, the UE 1001 determines that user plane resources of a PDU session are not established.

At 10003, the AMF 1003 and the SMF/UPF 1004 exchange signalling. This signalling relations to a modification of the PDU session. For example, the signalling may comprise at least one of Nsmf_PDUSession_UpdateSMContext and/or N4 Session Modification.

At 10004, the access node 1002 and the AMF 1003 exchange signalling. This signalling may cause N2 resources to be released.

When the timing information implies that the network slice becomes available, the UE can initiate the service request procedure in order to establish user plane resources of the PDU session associated with the network slice.

10005 to 10007 relate to a scenario in which the PDU session is released when the slice/S-NSSAI associated with the PDU session is unavailable.

At 10005, the UE 1001 locally releases the PDU session.

At 10006, the AMF 1003 and the SMF/UPF 1004 exchange signalling. This signalling relations to a release of the session. For example, the signalling may comprise at least one of Nsmf_PDUSession_ReleaseSMContext and/or N4 Session Release.

At 10007, the access node 1002 and the AMF 1003 exchange signalling. This signalling may cause N2 resources to be released.

In other words, in the example of FIG. 10, when the S-NSSAI becomes unavailable according to the timing information associated with the S-NSSAI, when the associated indication indicates to the UE that the PDU session associated with the S-NSSAI should not be released, then the UE considers that the user plan resources of the PDU session are not established. Alternatively, when the S-NSSAI becomes unavailable according to the timing information associated with the S-NSSAI and when the indication received by the UE indicates that the PDU session associated with the S-NSSAI should be released, then the UE may perform a local release of the PDU session.

Further, when the AMF has indicated to the SMF that the PDU session associated with the S-NSSAI should not be released, then the AMF may invoke the Nsmf_PDUSession_UpdateSMContext service for causing the SMF to modify the UPF resources. Alternatively, when the AMF has indicated to the SMF that the PDU session associated with the S-NSSAI should be released, then the AMF may invoke the Nsmf_PDUSession_ReleaseSMContext service for causing the SMF to release the UPF resources. The SMF may initiate a procedure to release the PDU session.

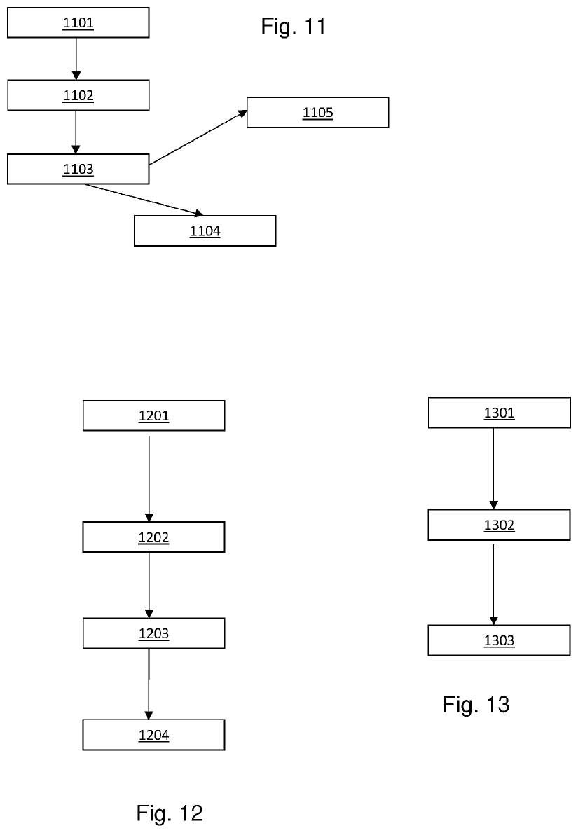

FIGS. 11 to 16 illustrate operations that may be performed by apparatus described herein. It is understood that as the following highlights aspects of the above examples, that they may be combined with features discussed in the above examples for some implementations.

FIG. 11 illustrates operations that may be performed by an apparatus for a user equipment.

At 1101, the apparatus communicates with a network using a first session associated with a first slice and/or a first data network name. The network may be considered to be an access point to a network. The network may be considered to be at least one network function location in a core network. The network may be considered to be an access and mobility function.

At 1102, the apparatus determines that the first slice and/or the first data network name is associated with timing information indicating that the first slice and/or the first data network name will stop being usable for the first session at a first time.

At 1103, the apparatus determines whether the first slice and/or the first data network name will become usable at a second time, the second time falling after the first time.

At 1104, when it is determined that the first slice and/or the first data network name will become usable for the first session at the second time, retaining context information associated with the first session.

At 1105, when it is determined that the first slice and/or the first data network name will not become usable for the first session at the second time, autonomously releasing said context information.

The user equipment of FIG. 11 may additionally or alternatively perform the features of FIG. 12, which illustrates operations that may be performed by an apparatus for a user equipment.

At 1201, the apparatus receives timing information for one or more network slices that the user equipment is allowed to use in a network. The apparatus may receive the timing information from a network function. For example, the apparatus may receive the timing information from at least one of: an access and mobility function, and/or an access point, and/or a user plane function, and/or a session management function.

At 1202, the apparatus determines whether a network slice is currently available to the user equipment based on the timing information. A network slice is considered to be available to the user equipment when the network slice is both allowed for the user equipment and is associated with timing information indicated that the network slice is valid at the time at which the determination is made.

At 1203, the apparatus releases user plane resources for a session associated with any network slice which is determined to be unavailable during 1202. The apparatus does not release user plane resources for session(s) associated with any network slice that is determined to be available during 1202.

At 1204, the apparatus triggers a procedure to re-establish user plane resources for a session associated with the network slice that is determined to become available subsequent to said releasing.

The following aspects may be applied to the apparatus of each of FIGS. 11 and 12.

The apparatus may signal, to the network, an indication that the apparatus is capable of performing said determining whether the first slice and/or the first data network name will become usable at the second time.

The apparatus may receive from the network, an indication that the network allows apparatus to perform said determining whether the first slice and/or the first data network name will become usable at the second time.

The apparatus may, when it is determined that the first slice and/or the first data network name will become usable for the first session at the second time, use the retained context information for communicating with a network using the first session at the second time.

The apparatus may receive the timing information from the network.

The timing information may indicate that the first slice and/or the first data network name is available periodically.

The first slice and/or the first data network name may be associated with a second session. In such a case, the apparatus may communicate with the network using the second session. When it is determined that the first slice and/or the first data network name will become usable for the second session at the second time, the apparatus may retain context information associated with the second session. When it is determined that the first slice and/or the first data network name will not become usable for the first session and second session at the second time, the apparatus may autonomously release said context information.

FIG. 13 illustrates operations that may be performed by an apparatus for a network function. The network function of FIG. 13 may correspond to any network and/or network function referred to in reference to any of FIGS. 11 and/or 12.

At 1301, the apparatus obtains timing information for one or more network slices that a user equipment is allowed to use in a network.

At 1302, the apparatus determines whether a network slice is currently unavailable to the user equipment based on the timing information.

At 1303, the apparatus invokes release of user plane resources in the network for a session associated with any network slice that is determined to be unavailable to the user equipment.

The apparatus of FIG. 13 may provide the obtained timing information to the user equipment. The apparatus of FIG. 13 may provide the obtained timing information to another network function (e.g., a session management function, an access and mobility function, and/or a user plane function).

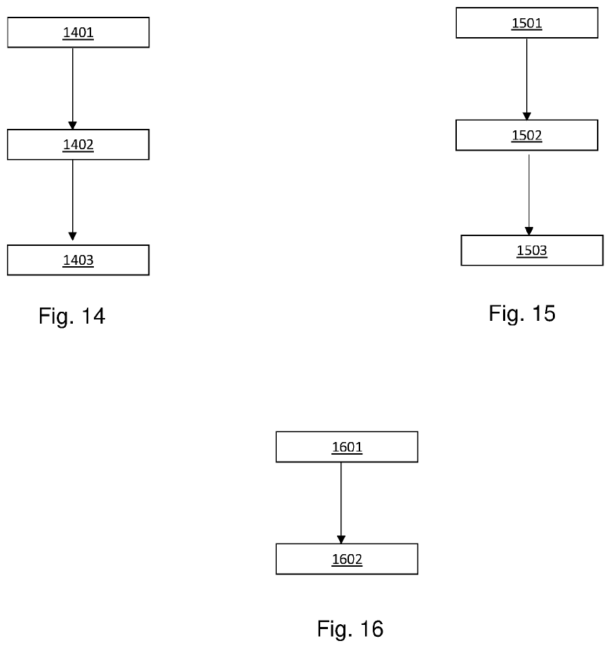

The operations of FIG. 13 may be combined with any of the features described below in relation to the operation of the apparatus of FIGS. 14 to 16.

FIG. 14 indicates operations that may be performed by an apparatus for an access and mobility function.

At 1401, the apparatus signals, to a session management function and/or a user plane function, a first request that a first session, associated with a first slice and/or a first data network name usable by a user equipment, be configured to allow an autonomous release of context information associated with the first session and/or to allow the retention of said context information when the first slice and/or the first data network name is temporarily unavailable, wherein the first slice and/or the first data network name is associated with timing information indicating that the first slice and/or the first data network name will stop being usable for the first session at a first time.

At 1402, the apparatus receives, from the session management function and/or user plane function, an indication of whether the first request has been allowed by the session management function.

At 1403, the apparatus signals said indication that the first request has been allowed to an access node when the first request has been allowed.

The apparatus may receive, from the user equipment, the first request.

The apparatus may determine a capability of the user equipment to perform the autonomous release of context information associated with the first session and/or to allow the retention of said context information when the first slice and/or the first data network name is temporarily unavailable; and generate the first request autonomously (e.g., in dependence on the determination of the capability).

The apparatus may locally store an identifier of the first slice and/or the first data network name and the timing information with context information for the user equipment.

The apparatus may provide an identifier of the first slice and/or the first data network name and the timing information to another access and mobility function as part of context information for the user equipment. This may be performed, for example, as part of a mobility-related operation (e.g., handover).

FIG. 15 illustrates operations that may be performed by an apparatus for a Session Management Function and/or a User Plane Function.

At 1501, the apparatus may, determine that a first session, associated with a first slice and/or a first data network name usable by a user equipment, be configured to allow an autonomous release of context information associated with the first session and/or to allow the retention of said context information when the first slice is temporarily unavailable, wherein the first slice and/or the first data network name is associated with timing information indicating that the first slice and/or the first data network name will stop being usable for the first session at a first time.

At 1502, the apparatus may configure and/or reconfiguring said first session in response to said determination.

At 1503, the apparatus may signal an indication of said configuration and/or reconfiguration to an access and mobility function.

The apparatus may receive, from the access and mobility function, a first request that the first session be configured to allow an autonomous release of context information associated with the first session and/or to allow the retention of said context information when the first slice and/or the first data network name is temporarily unavailable, wherein said determining is performed in response to receiving the first request.

When the first request comprises an indication that a user equipment associated with the first session is capable of performing an autonomous release of context information associated with the first session and/or of performing the retention of said context information when the first slice and/or the first data network name is temporarily unavailable, and whilst the context is retained, the apparatus may cause dropping of downlink packets for the session without performing a paging operation.

The apparatus may receive the timing information from the access and mobility function.

The apparatus may store (e.g., locally store) an identifier of the first slice and/or the first data network name and/or an Internet Protocol address allocated in context information for a user equipment associated with the first session.

FIG. 16 illustrates operations that may be performed by an apparatus for an access node (e.g., a gNB and/or radio access node).

At 1601, the apparatus receives from an access and mobility function, a first indication that a first session associated first context information is configured to allow first context information to be released autonomously by a user equipment when the first slice and/or the first data network name is determined to be unavailable and/or to be retained by the user equipment when the first slice and/or the first data network name is determined to be temporarily unavailable.

At 1602, the apparatus signals the first indication to the user equipment.

The apparatus may store said first indication in context information for the user equipment.

The apparatus may provide the first indication to another access node as part of context information for the user equipment. This may be provided during a mobility-related operation (e.g., during a handover).

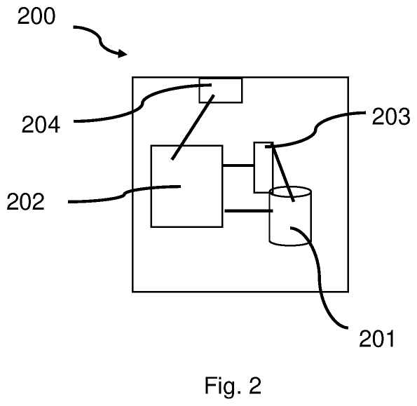

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions.

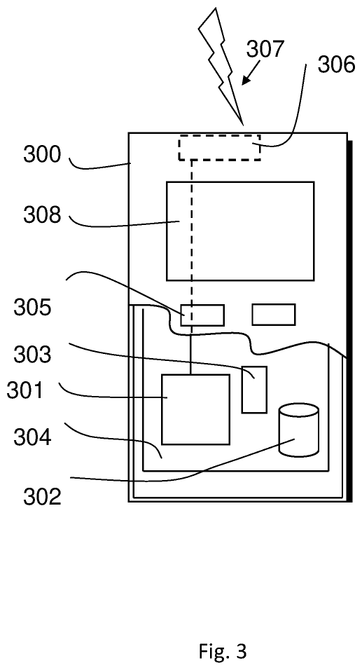

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories, for example hands-free equipment, thereto.

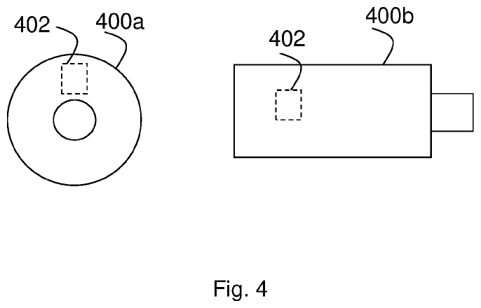

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 11 and/or FIG. 13, and/or FIG. 12, and/or FIG. 14, and/or FIG. 15, and/or FIG. 16, and/or methods otherwise described previously.

As provided herein, various aspects are described in the detailed description of examples and in the claims. In general, some examples may be implemented in hardware or special purpose circuits, software, logic or any combination thereof. For example, some aspects may be implemented in hardware, while other aspects may be implemented in firmware or software which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures, e.g., as in FIG. 11 and/or FIG. 12, and/or FIG. 13, and/or FIG. 14, and/or FIG. 15, and/or FIG. 16, and/or otherwise described previously, may represent program steps, or interconnected logic circuits, blocks and functions, or a combination of program steps and logic circuits, blocks and functions. The software may be stored on such physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (AStudy ItemC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

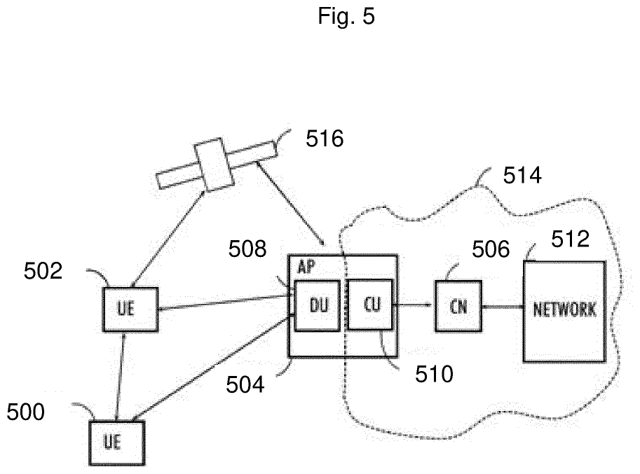

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support sidelink communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g)NodeB serving devices in a cell. In one example, the node 504 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 506 (CN or next generation core NGC). Depending on the deployed technology, the (e/g)NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHZ, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, 6 or above 24 GHZ-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The LTE network architecture is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). This may also be referred to as Edge computing when performed away from the core network. The communication system may also comprise a central control entity, or a like, providing facilities for networks of different operators to cooperate for example in spectrum sharing.

The technology of Edge computing may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where Edge computing servers can be placed between the core and the base station or nodeB (gNB). One example of Edge computing is MEC, which is defined by the European Telecommunications Standards Institute. It should be appreciated that MEC (and other Edge computing protocols) can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 5 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 5). A HNB Gateway (HNB-GW), which is typically installed within an operator's network may aggregate traffic from a large number of HNBs back to a core network.

1-7. (canceled)

8. An apparatus for an access and mobility function, the apparatus comprising:
at least one processor; and
at least one memory storing instructions that, when executed with the at least one processor, cause the apparatus to perform:
signalling, to a session management function, a first request that a first session, associated with a first slice usable with a user equipment wherein the first slice is associated with timing information indicating that the first slice will stop being usable for the first session at a first time;
receiving, from the session management function, an indication of whether the first request has been allowed with the session management function; and
signalling said indication that the first request has been allowed to an access node when the first request has been allowed.

9. An apparatus as claimed in claim 8, wherein the instructions, when executed with the at least one processor, cause the apparatus to perform receiving, from the user equipment, the first request.

10. An apparatus as claimed in claim 8, wherein the instructions, when executed with the at least one processor, cause the apparatus to perform:
determining a capability of the user equipment to at least one of perform the release of context information associated with the first session or allow the retention of said context information when the first slice is temporarily unavailable; and
generating the first request.

11. An apparatus as claimed in claim 8, wherein the instructions, when executed with the at least one processor, cause the apparatus to perform locally storing an identifier of the first slice and the timing information with context information for the user equipment.

12. An apparatus as claimed in claim 8, wherein the instructions, when executed with the at least one processor, cause the apparatus to perform providing an identifier of the first slice and the timing information to another access and mobility function as part of context information for the user equipment.

13-23. (canceled)

24. A method for an apparatus for an access and mobility function, the method comprising:
signalling, to a session management function, a first request that a first session, associated with a first slice usable with a user equipment, be configured to at least one of allow a release of context information associated with the first session or allow the retention of said context information when the first slice is temporarily unavailable, wherein the first slice is associated with timing information indicating that the first slice will stop being usable for the first session at a first time;
receiving, from the session management function, an indication of whether the first request has been allowed with the session management function; and
signalling said indication that the first request has been allowed to an access node when the first request has been allowed.

25-34. (canceled)

35. An apparatus as claimed in claim 8, wherein the first request is configured to at least one of allow a release of context information associated with the first session or allow the retention of said context information when the first slice is temporarily unavailable.

36. An apparatus for a user equipment, the apparatus comprising:
at least one processor; and
at least one memory storing instructions that, when executed with the at least one processor, cause the apparatus to perform:
communicating with a network using a first session associated with a first slice;
determining that the first slice is associated with timing information indicating that the first slice will stop being usable for the first session at a first time;
determining whether the first slice will become usable at a second time, the second time falling after the first time; and
when it is determined that the first slice become usable for the first session at the second time, retaining context information associated with the first session; and
when it is determined that the first slice will not become usable for the first session at the second time, releasing said context information.

37. An apparatus as claimed in claim 8, wherein the instructions, when executed with the at least one processor, cause the apparatus to perform signalling, to the network, an indication that the apparatus is capable of performing said determining whether the first slice will become usable at the second time.

38. An apparatus as claimed in claim 8, wherein the instructions, when executed with the at least one processor, cause the apparatus to perform receiving, from the network, an indication that the network allows the apparatus to perform said determining whether the first slice will become usable at the second time.

39. An apparatus as claimed in claim 8, wherein the instructions, when executed with the at least one processor, cause the apparatus to perform, when it is determined that the first slice will become usable for the first session at the second time, using the retained context information for communicating with a network using the first session at the second time.

40. An apparatus as claimed in claim 8, wherein the instructions, when executed with the at least one processor, cause the apparatus to perform receiving the timing information from the network.

41. An apparatus as claimed in claim 8, wherein the timing information indicates that the first slice is available periodically.

42. An apparatus as claimed in claim 8, wherein the first slice is associated with a second session, and the instructions, when executed with the at least one processor, cause the apparatus to perform:
communicating with the network using the second session; and
when it is determined that the first slice will become usable for the second session at the second time, retaining context information associated with the second session; and
when it is determined that the first slice will not become usable for the first session and second session at the second time, releasing said context information.
